(19) United States
(12) Patent Application Publication
(10) Pub. No.: US 2025/0347302 A1
(43) Pub. Date: Nov. 13, 2025

(54) MASKING METHOD FOR ELECTRICAL BOND PREPARATION AND STRENGTH PROPERTY PRESERVATION ABOUT A HOLE

(71) Applicant: The Boeing Company, Arlington, VA (US)

(72) Inventors: Jared Luke GUDINO, St. Louis, MO (US); Eric D. ZUELKE, St. Charles, MO (US); Victor Blakemore SLAUGHTER, Manchester, MO (US); Randall L. MARION, St. Charles, MO (US); Bruce Marshall GRIFFIN, St. Louis, MO (US)

(73) Assignee: The Boeing Company, Arlington, VA (US)

(21) Appl. No.: 19/076,545

(22) Filed: Mar. 11, 2025

Related U.S. Application Data
(60) Provisional application No. 63/644,815, filed on May 9, 2024.

(51) Int. Cl. F16B 5/02; F16B 33/00

(52) U.S. Cl. CPC F16B 5/02; F16B 33/008

(57) ABSTRACT

A method for electrical bond preparation and strength property preservation about a hole in a metal part during chemical processing. The method may include, prior to the chemical processing, applying a first adhesive maskant on a first side of the metal part to overlay the hole and a first area of the first side of the metal part surrounding the hole and applying a second adhesive maskant on a second side of the metal part to overlays the hole and a second area of the second side of the metal part surrounding the hole. The method may further include chemical processing the metal part then removing the first adhesive maskant and the second adhesive maskant, wherein the first adhesive maskant and the second adhesive maskant prevent exposure of the first area, the second area, and an inner side surface defining the hole to the chemical processing.

### RELATED APPLICATIONS

This application claims the benefit of U.S. Provisional Patent Application Ser. No. 63/644,815, filed May 9, 2024, which is incorporated herein by reference in its entirety.

### FIELD

This disclosure relates to chemical processing of metal substrates and, more particularly, to electrical bond preparation and strength property preservation about a hole in a metal substrate during chemical processing.

### BACKGROUND

Clearance holes allow an efficient assembly process for constructing large scale metal items or structural components. With clearance fit assembly, holes in each component are drilled separately, before components are chemically processed, brought together in a stack, and affixed together, which eliminates conventional requirements of components having to be stacked and aligned twice, as is associated with traditional methods of assembly. The large-scale metal items or structural components are typically secured together with metallic fasteners inserted through the drilled holes. Through processing, assembly, and use, the large-scale metal items and structural components may be susceptible to corrosion and environmental degradation.

The application of, or the formation of, surface coatings on the large-scale metal items and structural components is commonly used to reduce and/or eliminate corrosion and environmental degradation that can result from processing, assembly, and use. The chemical processes and surface treatments commonly implemented to apply such surface coatings (e.g., acid pickling, anodization, etc.), however, can have undesirable effects on the surface of the substrate in which the coating is applied, such as a decrease in the electrical conductivity of the coated surfaces and a reduction in fatigue life, which is especially problematic at the drilled holes.

It is desirable to provide a solution that allows for electrical bond preparation and strength property preservation about a hole in a metal part being chemical processed.

### SUMMARY

According to various implementations, a method for electrical bond preparation and strength property preservation about a hole in a metal part during chemical processing (e.g., anodization, acid pickling, conversion coating, chemical etching, passivation, etc.) is presented. For example, the present disclosure describes a method, and a resulting metal part or a metal part assembly (e.g., a part stack-up), in which portions of the metal part or parts of the assembly are masked during the chemical processing to avoid exposure of those masked areas to the chemical processing. In some implementations, the masking of the metal part may allow for electrical bond preparation between assembled parts and strength property preservation about a hole in a metal part.

In some implementations, the method may include, prior to the chemical processing, applying a first adhesive maskant on a first side of the metal part such that the first adhesive maskant overlays a hole in the metal part and a first area of the first side of the metal part surrounding the hole. In some implementations, the method may include, prior to the chemical processing, applying a second adhesive maskant on a second side of the metal part, opposite the first side, such that the second adhesive maskant overlays the hole and a second area of the second side of the metal part surrounding the hole. The method may further include chemical processing the metal part and removing the first adhesive maskant and the second adhesive maskant after chemical processing. In some implementations, the first adhesive maskant and the second adhesive maskant may prevent exposure of the first area, the second area, and an inner side surface defining the hole from the chemical processing.

In some implementations, the first adhesive maskant and the second adhesive maskant may be configured to withstand a process temperature of at least 200 degrees Fahrenheit for four hours. In some implementations, at least one of the first adhesive maskant and the second adhesive maskant may be transparent. In some implementations, the first adhesive maskant may include an adhesive, a backing, and a removable release liner, and wherein the first adhesive maskant does not contain silicone. In some implementations, the first adhesive maskant may be disc-shaped.

In some implementations, the chemical processing may include one or more of anodizing, chemical etching, pickling, conversion coating, and passivation of the metal part.

In some implementations, the hole may have a first diameter and the first area may have a second diameter that is larger than the first diameter. In some implementations, the second area may have a third diameter that is different than the second diameter.

In some implementations, the first area and the second area have at least one of a different fatigue life, a different electrical conductivity, a different thickness, and a different surface roughness than a portion of the first side that was exposed to the chemical processing.

In some implementations, a chemically processed metal part may include a first face, a second face opposite the first face, and a hole extending through the chemically processed metal part from the first face to the second face, where an inner side surface defining the hole, a first area surrounding the hole on the first face, and a second area surrounding the hole on the second face may not be chemically processed.

In some implementations, at least one of the first area and the second area may be circular.

In some implementations, the first area may be more electrically conductive than a chemically processed portion of the first face.

In some implementations, metal part may have a first thickness at the first area and a second thickness at a chemically processed portion of the first face, where the first thickness is different than the second thickness.

In some implementations, the first area may have a greater fatigue life than a chemically processed portion of the first face.

In some implementations, a metal part stack-up may include a first chemically processed metal part, a second chemically processed metal part, and a fastener attaching the first chemically processed metal part and the second chemically processed metal part together. In some implementations, the first chemically processed metal part may have a first face, a second face opposite the first face, and a first hole extending through the first chemically processed metal part from the first face to the second face and the second chemically processed metal part may have a third face, a fourth face opposite the third face, and a second hole extending through the second chemically processed metal part from the third face to the fourth face.

In some implementations, the first chemically processed metal part overlays the second chemically processed metal part such that the second face engages the third face and the first hole aligns with the second hole and the fastener is installed through the first hole and the second hole.

In some implementations, a first inner side surface defining the first hole and a second inner side surface defining the second hole may not be chemically processed. In some implementations, a first area surrounding the first hole on the first face, a second area surrounding the first hole on the second face, a third area surrounding the second hole on the third face, a fourth area surrounding the second hole on the fourth face may not be chemically processed.

In some implementations, a faying surface electrical bond may be formed between the first chemically processed metal part and the second chemically processed metal part through the second area and the third area. In some implementations, a spot electrical bond may be formed between the first chemically processed metal part and the second chemically processed metal part through the first area, the fastener, and the fourth area. In some implementations, a fastener shank electrical bond may be formed between the first chemically processed metal part and the second chemically processed metal part through the fastener, the first inner side surface defining the hole, and the second inner side surface defining the hole.

In some implementations, the fastener may include an extending portion and a mating portion connected to the extending portion. In some implementations, the chemically processed metal part stack-up may include a first spacer engaging the first face and a second spacer engaging the fourth face. In some implementations, a spot electrical bond may be formed through the first spacer and the second spacer.

In some implementations, the extending portion may have a first diameter and the second area may have a second diameter that is equal to or greater than the first diameter.

In some implementations, the first chemically processed metal part and the second chemically processed metal part may be chemically processed by one or more of anodizing, chemical etching, pickling, conversion coating, and passivation of the metal part.

In some implementations, the first area, the second area, the third area, and the fourth area may have at least one of a different fatigue life, a different electrical conductivity, or a different surface roughness than a chemically processed portion of the first face.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 is a perspective illustration of an example metal part with holes prior to chemical processing.

FIG. 2 is a cross-section illustration of the metal part of FIG. 1.

FIG. 3 is an enlarged perspective view of an example maskant being removed from the metal part with a tool.

FIG. 4 is a top illustration of the metal part of FIG. 1 with example maskants applied over the holes.

FIG. 5 is a bottom illustration of the metal part of FIG. 1 with example maskants applied over the holes.

FIG. 6 is a top illustration of the metal part of FIG. 4 after chemical processing.

FIG. 7 is a top illustration of the metal part of FIG. 6 after the maskants are removed.

FIG. 8 is side view of an example part stack-up showing a fay surface electrical bond.

FIG. 9 is side view of an example part stack-up showing a spot electrical bond.

FIG. 10 is side view of an example part stack-up showing a fastener shank electrical bond.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

These and other features and advantages are shown and described herein in reference to the figures.

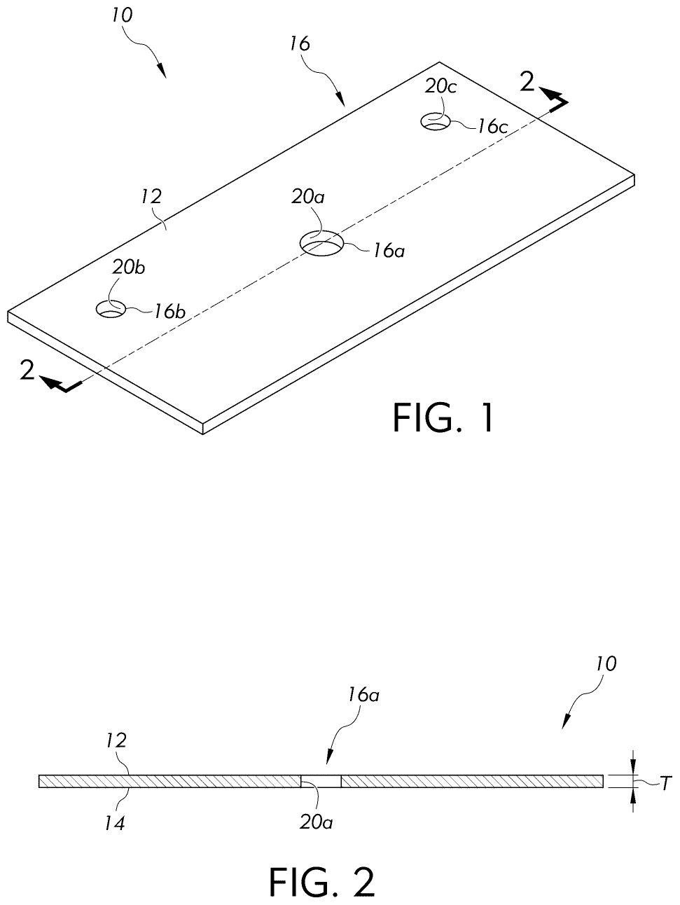

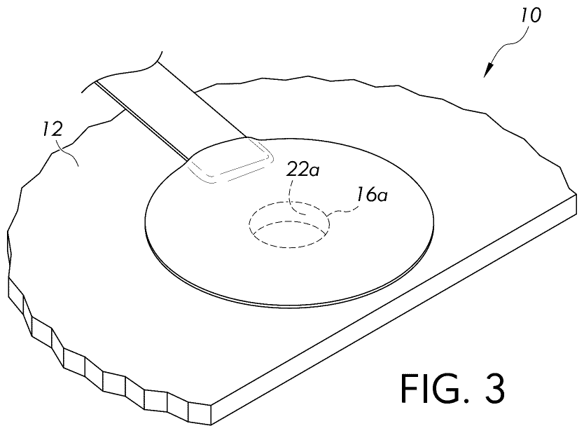

FIGS. 1-2 illustrate an example metal part 10 (e.g., a metal item, a metal substrate, a metal component, etc.) according to the present disclosure. As will be discussed within this disclosure, the metal part 10 may undergo chemical processing (e.g., anodization, acid pickling, conversion coating, chemical etching, passivation, etc.) to affect characteristics of the metal part 10. The present disclosure describes a method, and a resulting metal part 10 or a metal part assembly 30 (e.g., a part stack-up), in which portions of the metal part 10 or parts of the assembly are masked during the chemical processing to avoid exposure of those masked areas to the chemical processing. In some implementations, the metal part 10 may have one or more holes extending through the metal part 10. In some implementations, the masking of the metal part 10 may allow for electrical bond preparation between assembled parts and strength property preservation about a hole in a metal part 10.

Referring to FIGS. 1-2, the metal part 10 may be configured in a variety of ways, including shape, size, type of metal, the number and location of holes through the part, etc. In some implementations, the metal part 10 is made from a variety of metals, such as aluminum, stainless steel, titanium, etc. The type of metal used in the metal part 10 may be related to the type of chemical processing being performed. For example, if the metal part 10 is made from aluminum or another nonferrous metal, the chemical process may be anodization, or if the metal part 10 is stainless steel, the chemical process may be passivation, etc. In some implementations, the metal part 10 is a machined part.

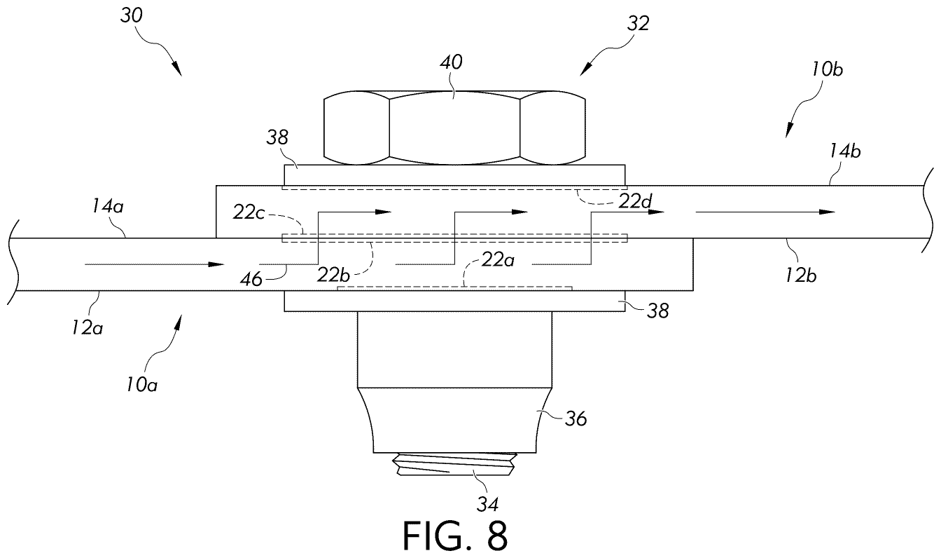

In some implementations, the metal part 10 may have a first face 12, a second face 14 opposite the first face 12, and a thickness T. In some implementations, the first face 12 may be parallel to the second face 14. In some implementations, the metal part 10 may be formed as a plate, a housing, a casing, or a sheet. As shown in FIGS. 1-2, in some implementations, the metal part 10 includes one or more holes 16 extending through the metal part 10 from the first face 12 to the second face 14. Each of the one or more holes 16 may be configured to receive a fastener 32 (FIGS. 8-10) to attach the metal part 10 to one or more additional parts or components.

The one or more holes 16 may be configured in a variety of ways, including the shape, the size, the location, the number, the arrangement, etc. of the holes 16. In some implementations, the metal part 10 may include a first circular hole 16a having a first diameter D1, a second circular hole 16b having a second diameter D2, and a third hole 16c having a third diameter D3. In other implementations, the metal part 10 may include more or less than three holes and the shape of the holes may be other than circular (e.g., oval, rectangular, etc.).

In some implementations, one or more of the holes 16 may be sized different than one or more other of the holes 16. For example, in some implementations, the first diameter D1 is larger than both the second diameter D2 and the third diameter D3. In some implementations, one or more of the holes 16 may be sized the same as one or more other of the holes 16. For example, in some implementations, the second diameter D2 is the same size as the third diameter D3.

The first hole 16a may be defined by a first inner side surface 20a (e.g., a bore surface) of the metal part 10 extending between the first face 12 and the second face 14. Similarly, the second hole 16b may be defined by a second inner side surface 20b and the third hole 16c may be defined by a third inner side surface 20c.

Referring to FIGS. 3-5, maskants 22 may be used to cover one or more holes 16 and surrounding areas about the one or more holes 16 on the metal part 10 prior to a chemical process on the metal part 10. Each maskants 22 may be configured to be applied onto a face of the metal part 10 to shield the inner surface side surface of one or more of the holes 16 and the area surrounding the one or more holes 16 from a chemical process being applied to the face.

The maskants 22 may be configured in a variety of ways, including shape, size, composition, etc. In some implementations, the maskants 22 may include an adhesive. For example, in some implementations, the maskants 22 may include an adhesive (e.g., a non-silicone adhesive, a rubber adhesive, or other suitable adhesive) applied to a substrate or backing (e.g., vinyl, polyester, or other suitable material). In other implementation, the maskants 22 may be configured to be attached to the metal part 10 via a separate adhesive.

In some implementations, the maskants 22 may be transparent, which aids in verifying that the maskants 22 are satisfactorily positioned on the metal part 10. In some implementations, the maskants 22 do not include silicone. In some implementations, the maskants 22 may include a removable release liner (e.g., polyester or other suitable liner) that is configured to be removed to expose the adhesive.

In some implementations, the maskants 22 may be configured to withstand the conditions associated with the chemical processing that the metal part 10 will receive. For example, in some implementations, the maskants 22 may be configured to withstand (i.e., continue to shield the inner surface side surface of the one or more of the holes 16 and the area surrounding the one or more holes 16) the conditions associated with chemical etching and anodizing the metal part 10. In some implementations, the maskants 22 may be configured to withstand a chemical etching and an anodizing process having a maximum process temperature of 200 degrees Fahrenheit for four hours. In some implementations, the maskants 22 may be configured to withstand increased air pressure within the hole.

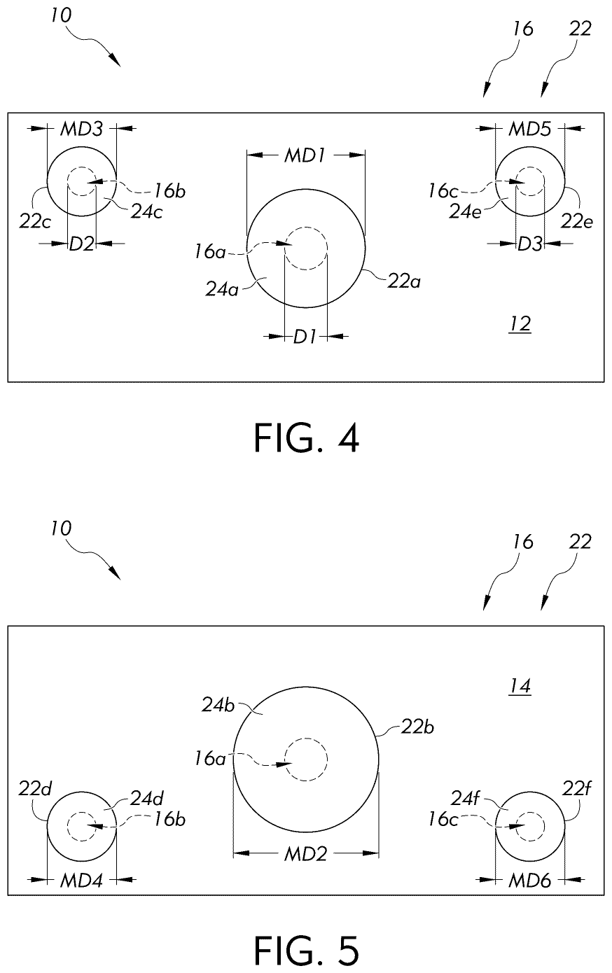

Referring to FIGS. 4-5, one or more of the maskants 22 may be applied to both the first face 12 and to the second face 14 to cover one or more holes 16 on both sides of the holes. In some implementations, a maskant 22 may be configured to cover a single hole 16 and an area 24 surrounding the hole 16. In other embodiments, a maskant 22 may be configured to cover more than one hole 16 and the area surrounding the more than one hole 16.

For example, in the illustrated implementation, a first maskant 22a may be applied to the first face 12 to cover the first hole 16a and a first area 24a surrounding the first hole 16a. The first maskant 22a may be placed onto the first face 12 such that an adhesive on the maskant 22a (or a separate adhesive) contacts the first face 12 to attach the maskant 22a to the first face 12.

Similarly, a second maskant 22b may be applied to the second face 14 to cover the first hole 16a and a second area 24b surrounding the first hole 16a on the second face 14. In some implementations, the first maskant 22a and the second maskant 22b may be disc-shaped (i.e., having a circular profile). In other implementations, the first maskant 22a and/or the second maskant 22b may be shaped other than circular. In some implementations, the first maskant 22a has a first maskant diameter MD1 and the second maskant 22b has a second maskant diameter MD2. In some implementations, the first maskant diameter MD1 may be different (i.e., larger or smaller) than the second maskant diameter MD2. Thus, the first area 24a may be a different size (i.e., larger or smaller) than the second area 24b. In other implementations, the first area 24a and the second area 24b may be the same size. In some implementations, the first maskant diameter MD1 may be at least 1.5 times the diameter D1 of the first hole, at least twice the size of the diameter D1 of the first hole 16a, or at least 2.5 times the size of the diameter D1 of the first hole 16a.

Similar to the first and the second maskants 22a, 22b, additional maskants 22 may be used to cover the second hole 16b and the third hole 16c on both sides of the metal part 10. For example, in some implementations, a third maskant 22c may be applied to the first face 12 to cover the second hole 16b and a third area 24c surrounding the second hole 16b and a fourth maskant 22d may be applied to the second face 14 to cover the second hole 16b and a fourth area 24d surrounding the second hole 16b. Likewise, in some implementations, a fifth maskant 22e may be applied to the first face 12 to cover the third hole 16c and a fifth area 24e surrounding the third hole 16c and a sixth maskant 22f may be applied to the second face 14 to cover the third hole 16c and a sixth area 24f surrounding the third hole 16c.

In some implementations, the third, fourth, fifth, and sixth maskants 22c-22f may be disc-shaped (i.e., having a circular profile). In other implementations, one or more of the third, fourth, fifth, and sixth maskants 22c-22f may be shaped other than circular. In some implementations, the third maskant 22c has a third maskant diameter MD3, the fourth maskant 22d has a fourth maskant diameter MD4, the fifth maskant 22e has a fifth maskant diameter MD5, and the sixth maskant 22f has a sixth maskant diameter MD6. In some implementations, one or more of the maskant diameters of any of the maskants 22a-22f may be the same or may be different (i.e., larger or smaller) than one or more of the other maskants. Thus, one or more of the areas 24a-24f may be the same or may be a different size (i.e., larger or smaller) than one or more other of the areas. In some implementations, the maskant diameter of a maskant may be at least 1.5 times the size of the diameter of the hole which the maskant covers, at least twice the size of the diameter of the hole which the maskant covers, or at least 2.5 times the size of the diameter of the hole the maskant covers.

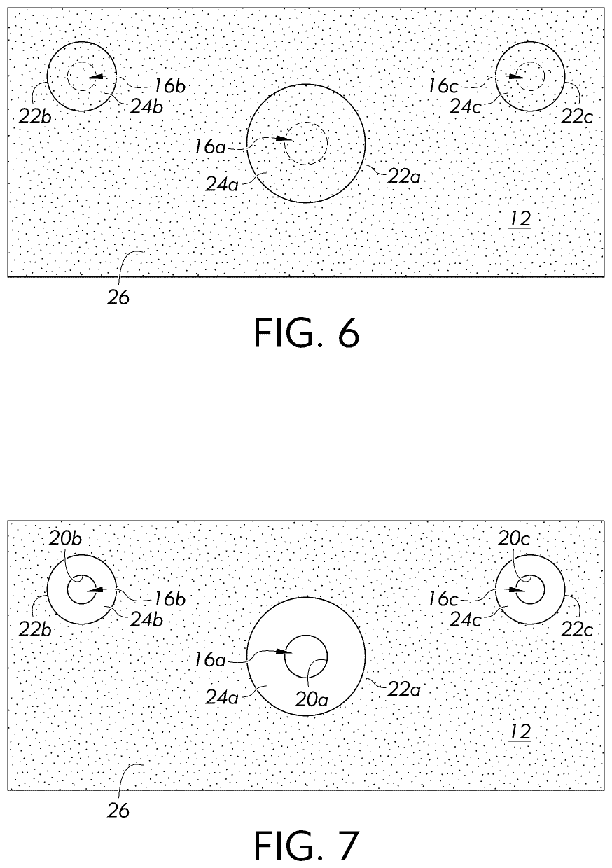

Referring to FIG. 6, with the maskants 22 in place, the metal part 10 may undergo chemical processing (e.g., anodization, acid pickling, conversion coating, chemical etching, passivation, etc. or a combination thereof) (illustrated as the dot pattern overlaying the first and second faces 12, 14) to affect characteristics of the metal part 10 (e.g., characteristics of the first and second faces 12, 14). FIG. 6 illustrates the first face 12 after the metal part 10 has undergone chemical processing. It is understood that, though not illustrated, the second face 14 may receive the same chemical processing as the first face 12 (e.g., simultaneously with the first face 14).

The maskants 22 may be configured to shield the inner side surfaces of the holes 16 and the areas 24 surrounding the holes 16, which the maskants 22 cover (i.e., the masked areas), from being exposed to and affected by the chemical process. Referring to FIG. 7, the maskants 22 may be removed from the first face 12 and the second face 14 after the chemical processing is complete. The maskants 22 may be configured to be removed in a variety of ways. In some implementations, the maskants 22 may be configured to be peeled off of the surface by hand or with a tool (as shown in FIG. 3). In some implementations, the maskants 22 may be configured to be scraped off with a tool.

As shown in FIG. 7, once the maskants 22 are removed, the inner side surfaces 20a-20c of the holes 16 and the areas 24 surrounding the holes 16 that were covered by the maskants 22 have not been affected by the chemical process. Thus, the first face 12 and second face 14 include one or more chemically processed portions 26 while the areas 24a-24f and the inner side surfaces 20a-20c have not been affected by the chemical process.

The effect of the chemical processing on the metal part 10 may depend on the type of chemical processing used. For example, the chemical processing may affect properties of the metal part 10 such as, but not limited to, fatigue life, electrical conductivity, thickness, surface roughness, corrosion resistance, wear resistance, ductility, appearance, thermal conductivity, etc.

In some implementations, the thickness of the chemically processed portions 26 of the metal part 10 are different than the thickness of the areas 24a-24f. In some implementations, for example, the chemical processing may add a coating or finish (e.g., anodizing aluminum can create a surface layer of amorphous aluminum oxide that is 2 to 3 nm thick) such that the chemically processed portions 26 are thicker than the areas 24a-24f. In some implementations, the chemical processing may remove material (e.g., metal pickling may remove a small amount from the metal part such as 1-3% metal mass) such that the chemically processed portions 26 are thinner than the areas 24a-24f.

In some implementations, the areas 24a-24f and inner surfaces 20a-20c may have better electrical conductivity than the chemically processed portions 26 (e.g., the oxide layer created during anodization has poor electrical conductivity). In some implementations, the areas 24a-24f and inner side surfaces 20a-20c have better fatigue life and/or are more ductile than the chemically processed portions 26 (e.g., the oxide layer created during anodization of a metal is more brittle and prone to crack propagation than the unanodized metal).

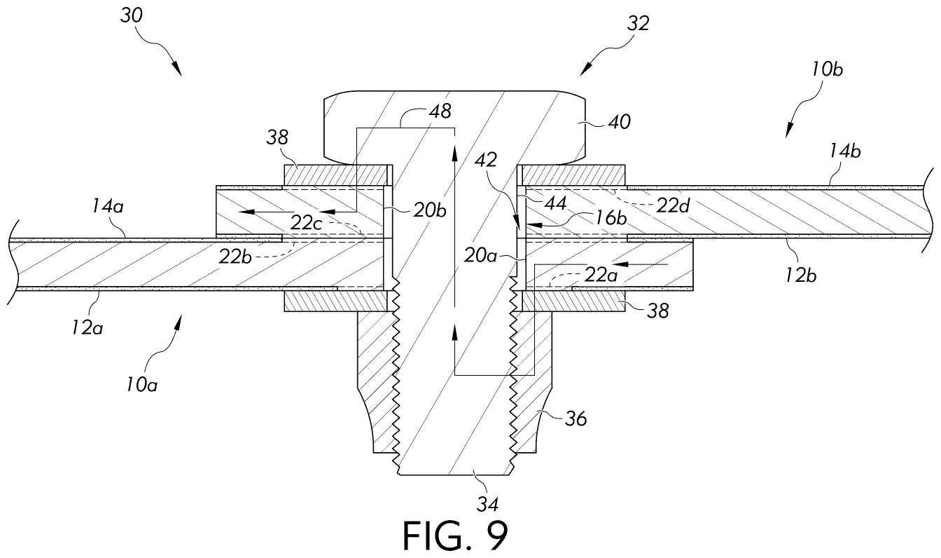

FIGS. 8-9 illustrate an example implementation of a part assembly 30 having two or more metal parts 10. The part assembly 30 may be configured in a variety of ways, including orientation of the parts, number of parts, how the parts are held together, thickness of the parts, etc.

The first metal part 10a and the second metal part 10b may be substantially similar to the metal part 10 from FIGS. 1-7. The first metal part 10a may include a first face 12a, a second face 14a, and a first hole 16a defined by a first inner side surface 20a. Likewise, the second metal part 10b may include a third face 12b, a fourth face 14b, and a second hole 16b defined by a second inner side surface 20b. The first metal part 10a and the second metal part 10b have been chemically processed, as described above. The first face 12a may include a first area 24a and the second face 14a may include a second area 24b that were masked by a maskant 22 during chemical processing such that the first area 24a, the second area 24b, and the first inner side surface 20a were unaffected by the chemical processing, as described above. Likewise, the third face 12b may include a third area 24c and the fourth face 14b may include a fourth area 24d.

In some implementations, the part assembly 30 may be a part stack-up (two or more parts attached together is a stacked arrangement) having the first metal part 10a attached face-to-face to the second metal part 10b via a fastener 32. For example, in some implementations, the second metal part 10b overlays the first metal part 10a such that the second face 14a of the first metal part 10a contacts the third face 12b of the second metal part 10b and the first hole 16a is aligned with the second hole 16b. In this arrangement, the second area 24b of the first metal part 10a contacts the third area 24c of the second metal part 10b.

The fastener 32 may be installed through the first hole 16a and the second hole 16b to attach the first and second metal parts 10a, 10b together. The fastener 32 may be configured in a variety of ways. In some implementations, the fastener 32 includes an extending portion 34 (e.g., a bolt, a pin, etc.), a mating portion 36 (e.g., a nut, a collar, etc.), and one or more optional spacers 38 (e.g., a washer, etc.). In some implementations, the extending portion 34 may include a head portion 40.

In some implementations, when in use, the extending portion 34 may extend through the first and second holes 16a, 16b with an optional spacer 38 captured between the head portion 40 and the fourth face 14b and a second optional spacer 38 captured between the mating portion 36 and the first face 12a. As shown in FIG. 9, in some implementations, when in use, there may be a gap or clearance 42 between an outer surface 44 of the extending portion 34 and the first inner side surface 20a and the second inner side surface 20b.

As indicated above, some chemical processing, such as anodization, may negatively impact the electrical conductivity of the chemically processed surfaces. For example, anodization creates an oxide coating or film on the first, second, third, and fourth faces 12a, 14a, 12b, 14b that is non-electrically conductive. This is problematic for applications where an electrical bond between parts is used to protect systems from electromagnetic effects. The areas 22a-22d and the hole bore surfaces 20a, 20b, however, provide electrically conductive surfaces unaffected by the chemical processing. As a result, one or more electrical bonds may be formed between the first metal part 10a and the second metal part 10b.

For example, referring to FIG. 8, a faying surface electrical bond (i.e., an electrical bond between the faying surfaces of the first metal part 10a and the second metal part 10b), as shown by arrows 46, may be formed between the first metal part 10a and the second metal part 10b through the contact between the second area 24b on the first metal part 10a and the third area 24c on the second metal part 10b. As indicated above, the maskants 22 shielded the second area 24b of the first metal part 10a and the third area 24c of the second metal part 10b from the chemical processing. Thus, the electrical conductivity of the second area 24b and the third area 24c are not negatively impacted by the chemical processing and can form the faying surface electrical bond in the part assembly 30.

Referring to FIG. 9, a spot electrical bond, as shown by arrows 48, may be formed between the first metal part 10a and the second metal part 10b through a conductive path formed between the first area 24a, the fastener 32, and the fourth area 24d. In some implementations, the conductive path may include multiple portions of the fastener 32. For example, in the example of FIG. 9, the conductive path includes first area 24a, both spacers 38, the mating portion 36, the extending portion 34, the head portion 40, and the fourth area 24d.

As indicated above, the maskants 22 shielded the first area 24a of the first metal part 10a and the fourth area 24d of the second metal part 10b from the chemical processing. Thus, the electrical conductivity of the second area 24b and the third area are not negatively impacted by the chemical processing and can form part of the spot electrical bond path in the part assembly 30.

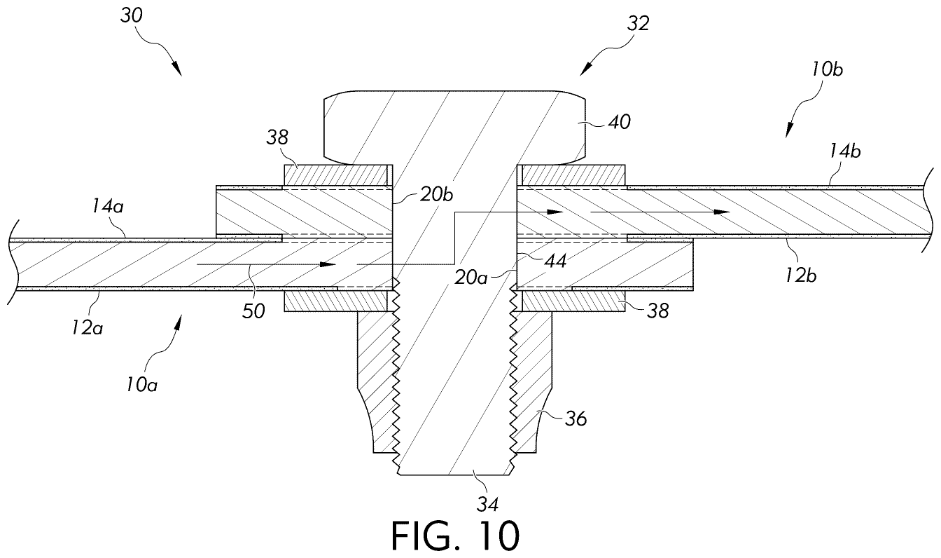

Referring to FIG. 10, a fastener shank electrical bond, as shown by arrows 50, may be formed between the first metal part 10a and the second metal part 10b through the inner side surfaces 20a, 20b and the extending portion 34. In the example of FIG. 10, the extending portion 34 is sized such that the outer surface 44 contacts the inner side surfaces 20a, 20b. As indicated above, the maskants 22 shielded the inner side surfaces 20a, 20b from the chemical processing. Thus, the electrical conductivity of the inner side surfaces 20a, 20b is not negatively impacted by the chemical processing and can form part of the fastener shank electrical bond path in the part assembly 30.

As indicated above, some chemical processing, such as anodization, may negatively impacts the strength properties (e.g., fatigue life) of the chemically processed surfaces. For example, anodization is known to reduce the fatigue life of the anodized surfaces. This can be problematic, especially at joints (e.g., the holes 16 receive the fastener 32 to hold the parts together) between parts due to the higher stresses associated with the joints. The maskants 22, however, shield the inner side surfaces 20a-20c from being affected by the chemical processing. As a result, the holes 16 retain their strength properties (e.g., fatigue life).

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. Although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A method for electrical bond preparation and strength property preservation about and in a hole in a metal part during chemical processing, the method comprising:
prior to the chemical processing, applying a first adhesive maskant on a first side of the metal part such that the first adhesive maskant overlays the hole and a first area of the first side of the metal part surrounding the hole;
prior to the chemical processing, applying a second adhesive maskant on a second side of the metal part, opposite the first side, such that the second adhesive maskant overlays the hole and a second area of the second side of the metal part surrounding the hole,
chemical processing the metal part; and
removing the first adhesive maskant and the second adhesive maskant; and
wherein the first adhesive maskant and the second adhesive maskant prevent exposure of the first area, the second area, and an inner side surface defining the hole from the chemical processing.

2. The method of claim 1, wherein the first adhesive maskant and the second adhesive maskant are configured to withstand a process temperature of at least 200 degrees Fahrenheit for four hours.

3. The method of claim 1, wherein at least one of the first adhesive maskant and the second adhesive maskant are transparent.

4. The method of claim 1, wherein the first and/or second adhesive maskant includes an adhesive, a backing, and a removable release liner, and wherein the first adhesive maskant does not contain silicone.

5. The method of claim 1, wherein the chemical processing includes one or more of anodizing, chemical etching, pickling, conversion coating, and passivation of the metal part.

6. The method of claim 1, wherein the first and/or second adhesive maskant is disc-shaped and/or shaped other than circular.

7. The method of claim 1, wherein the hole has a first diameter and the first area has a second diameter that is greater than the first diameter.

8. The method of claim 7, wherein the second area has a third diameter that is different than the second diameter.

9. The method of claim 1, wherein after chemical processing, the first area and the second area have at least one of a different fatigue life, a different electrical conductivity, a different thickness, and a different surface roughness than a portion of the first side that was exposed to the chemical processing.

10. A chemically processed metal part, comprising:
a first face;
a second face opposite the first face; and
a hole extending through the chemically processed metal part from the first face to the second face; and
wherein an inner side surface defining the hole, a first area surrounding the hole on the first face, and a second area surrounding the hole on the second face are not chemically processed.

11. The chemically processed metal part of claim 10, wherein at least one of the first area and the second area are circular.

12. The chemically processed metal part of claim 10, wherein the first area is more electrically conductive than a chemically processed portion of the first face.

13. The chemically processed metal part of claim 10, wherein the metal part has a first thickness at the first area and the metal part has a second thickness at a chemically processed portion of the first face; and wherein the first thickness is different than the second thickness.

14. The chemically processed metal part of claim 10, wherein the first area has a greater fatigue life than a chemically processed portion of the first face.

15. A metal part stack-up, comprising:
a first chemically processed metal part having a first face, a second face opposite the first face, and a first hole extending through the first chemically processed metal part from the first face to the second face;
a second chemically processed metal part having a third face, a fourth face opposite the third face, and a second hole extending through the second chemically processed metal part from the third face to the fourth face, wherein the first chemically processed metal part overlays the second chemically processed metal part such that the second face engages the third face and the first hole aligns with the second hole; and
a fastener received through the first hole and the second hole;
wherein a first inner side surface defining the first hole and a second inner side surface defining the second hole are not chemically processed;
wherein a first area surrounding the first hole on the first face, a second area surrounding the first hole on the second face, a third area surrounding the second hole on the third face, a fourth area surrounding the second hole on the fourth face are not chemically processed;
wherein a faying surface electrical bond is formed between the first chemically processed metal part and the second chemically processed metal part through the second area and the third area;
wherein a spot electrical bond is formed between the first chemically processed metal part and the second chemically processed metal part through the first area, the fastener, and the fourth area; and
wherein a fastener shank electrical bond is formed between the first chemically processed metal part and the second chemically processed metal part through the first inner side surface defining the first hole, the fastener, and the second inner side surface defining the second hole.

16. The metal part stack-up of claim 15, wherein the fastener comprises an extending portion and a mating portion connected to the extending portion, and wherein the chemically processed metal part stack-up further comprises a first spacer engaging the first face and a second spacer engaging the fourth face.

17. The metal part stack-up of claim 16, wherein the spot electrical bond is formed through the first spacer and the second spacer.

18. The metal part stack-up of claim 16, wherein the extending portion has a first diameter and the second area has a second diameter that is equal to or greater than the first diameter.

19. The metal part stack-up of claim 15, wherein the first chemically processed metal part and the second chemically processed metal part have been chemically processed by one or more of anodizing, chemical etching, pickling, conversion coating, and passivation of the metal part.

20. The metal part stack-up of claim 15, wherein the first area, the second area, the third area, and the fourth area have at least one of a different fatigue life, a different electrical conductivity, a different thickness, and a different surface roughness than a chemically processed portion of the first face.
